(19) United States
(12) Patent Application Publication
(10) Pub. No.: US 2025/0310972 A1
(43) Pub. Date: Oct. 2, 2025

(54) DCI Processing Method, UE, and Network-Side Device

(71) Applicant: VIVO MOBILE COMMUNICATION CO.,LTD., Dongguan (CN)

(72) Inventors: Can Li, Dongguan (CN); Siqi Liu, Dongguan (CN)

(21) Appl. No.: 19/235,715

(22) Filed: Jun. 12, 2025

Related U.S. Application Data
(63) Continuation of application No. PCT/CN2023/137908, filed on Dec. 11, 2023.

(30) Foreign Application Priority Data
Dec. 15, 2022 (CN) 202211616818.7

(51) Int. Cl. H04W 72/232; H04L 5/00

(52) U.S. Cl. CPC H04W 72/232; H04L 5/0053

(57) ABSTRACT

A DCI processing method includes a UE receiving a first DCI, wherein the first DCI is used for jointly scheduling or indicating downlink transmissions corresponding to a plurality of physical units, and at least one first physical unit of the plurality of physical units meets a first condition. The UE performs a first operation based on the first DCI, wherein the first operation includes at least one of the following; not receiving or not decoding the downlink transmission corresponding to the first physical unit.

### CROSS-REFERENCE TO RELATED APPLICATIONS

This application is a Bypass Continuation Application of International Patent Application No. PCT/CN2023/137908 filed Dec. 11, 2023, and claims priority to Chinese Patent Application No. 202211616818.7 filed Dec. 15, 2022, the disclosures of which are hereby incorporated by reference in their entireties.

### BACKGROUND OF THE INVENTION

### Field of the Invention

This application pertains to the field of communication technologies, and in particular, relates to a DCI processing method, a UE, and a network-side device.

### Description of Related Art

In a case that at least one of cells that are scheduled jointly with downlink control information (DCI) is in a deactivated state, or at least one of the cells is in a bandwidth part (BWP) dormancy state, or at least one symbol of one of the cells conflicts with an uplink symbol in a time-division duplex (TDD) configuration, a behavior of receiving or decoding the DCI and scheduled downlink transmissions is not determined.

### SUMMARY OF THE INVENTION

According to a first aspect, a DCI processing method is provided. The method is applied to a UE and includes: receiving, by a UE, first DCI, where the first DCI is used for jointly scheduling or indicating downlink transmissions corresponding to a plurality of physical units, and at least one first physical unit of the plurality of physical units meets a first condition; and performing, by the UE, a first operation based on the first DCI, where the first operation includes at least one of the following: not receiving or not decoding the downlink transmission corresponding to the first physical unit.

According to a second aspect, a DCI processing apparatus is provided. The apparatus includes a receiving module and an execution module. The receiving module is configured to: receive first DCI, where the first DCI is used for jointly scheduling or indicating downlink transmissions corresponding to a plurality of physical units, and at least one first physical unit of the plurality of physical units meets a first condition. The execution module is configured to: perform a first operation based on the first DCI, where the first operation includes at least one of the following: not receiving or not decoding the downlink transmission corresponding to the first physical unit.

According to a third aspect, a DCI processing method is provided. The method is applied to a network-side device and includes: in a case that first downlink control information DCI is used for jointly scheduling or indicating downlink transmissions corresponding to a plurality of physical units, and at least one of the plurality of physical units meets a first condition, performing, by a network side, a second operation on the first DCI, where the second operation includes sending the first DCI to a user equipment UE or not sending the first DCI to a UE.

According to a fourth aspect, a DCI processing apparatus is provided. The apparatus includes an execution module. The execution module is configured to: in a case that first downlink control information DCI is used for jointly scheduling or indicating downlink transmissions corresponding to a plurality of physical units, and at least one of the plurality of physical units meets a first condition, perform a second operation on the first DCI, where the second operation includes sending the first DCI to a user equipment UE or not sending the first DCI to a UE.

According to a fifth aspect, a UE is provided. The UE includes a processor and a memory. The memory stores a program or instructions that are executable on the processor. When the program or instructions are executed by the processor, steps of the method according to the first aspect are performed.

According to a sixth aspect, a UE is provided, including a processor and a communication interface. The processor is configured to: receive first DCI, and perform a first operation based on the first DCI.

According to a seventh aspect, a network-side device is provided. The network-side device includes a processor and a memory. The memory stores a program or instructions that are executable on the processor. When the program or instructions are executed by the processor, steps of the method according to the third aspect are performed.

According to an eighth aspect, a network-side device is provided, including a processor and a communication interface. The processor is configured to: in a case that first downlink control information DCI is used for jointly scheduling or indicating downlink transmissions corresponding to a plurality of physical units, and at least one of the plurality of physical units meets a first condition, perform a second operation on the first DCI.

According to a ninth aspect, a DCI processing system is provided, including a UE and a network-side device. The UE may be used to perform steps in the method according to the first aspect. The network-side device may be used to perform steps in the method according to the third aspect.

According to a tenth aspect, a non-transitory readable storage medium is provided. The non-transitory readable storage medium stores a program or instructions. When the program or instructions are executed by a processor, steps of the method according to the first aspect or steps in the method according to the third aspect are performed.

According to an eleventh aspect, a chip is provided. The chip includes a processor and a communication interface. The communication interface is coupled to the processor. The processor is configured to run a program or instructions, to perform steps in the method according to the first aspect or steps in the method according to the third aspect.

According to a twelfth aspect, a computer program/program product is provided. The computer program/program product is stored in a non-transitory storage medium. The computer program/program product is executed by at least one processor to perform steps in the method according to the first aspect or steps in the method according to the third aspect.

### BRIEF DESCRIPTION OF THE DRAWINGS

FIG. 1 is a diagram of an architecture of a communication system according to an embodiment of this application;

FIG. 2 is a diagram of a dynamic codebook according to an embodiment of this application;

FIG. 3 is a first flowchart of a DCI processing method according to an embodiment of this application;

FIG. 4 is a second flowchart of a DCI processing method according to an embodiment of this application;

FIG. 5 is a first diagram of a structure of a DCI processing apparatus according to an embodiment of this application;

FIG. 6 is a second diagram of a structure of a DCI processing apparatus according to an embodiment of this application;

FIG. 7 is a diagram of a hardware structure of a communication device according to an embodiment of this application;

FIG. 8 is a diagram of a hardware structure of a UE according to an embodiment of this application; and

FIG. 9 is a diagram of a hardware structure of a network-side device according to an embodiment of this application.

### DESCRIPTION OF THE INVENTION

The following clearly describes technical solutions in embodiments of this application with reference to the accompanying drawings in embodiments of this application. It is clear that the described embodiments are some rather than all of embodiments of this application. All other embodiments obtained by persons of ordinary skill in the art based on embodiments of this application all fall within the protection scope of this application.

In the specification and claims of this application, the terms such as “first” and “second” are intended to distinguish between similar objects but not to describe a particular order or sequence. It should be understood that the terms used in this way are interchangeable in appropriate circumstances, so that embodiments of this application can be implemented in an order other than the orders illustrated or described herein. In addition, objects distinguished between by “first” and “second” are usually of a same category, and a quantity of objects is not limited. For example, there may be one or more first objects. In addition, in the specification and claims, “and/or” indicates at least one of the connected objects, and the character “/” usually indicates an “or” relationship between the contextually associated objects.

It should be noted that the technologies described in embodiments of this application are not limited to being used in long term evolution (LTE)/LTE-advanced (LTE-A) systems, and may also be used in other wireless communication systems such as code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and other systems. The terms “system” and “network” in embodiments of this application are usually used interchangeably. The technologies described can be used in the systems and radio technologies mentioned above, and can also be used in other systems and radio technologies. The following describes a new radio (NR) system as an example, and NR terms are used in most of the following descriptions. However, these technologies can also be used in systems other than the NR system, for example, a 6th generation (6G) communication system.

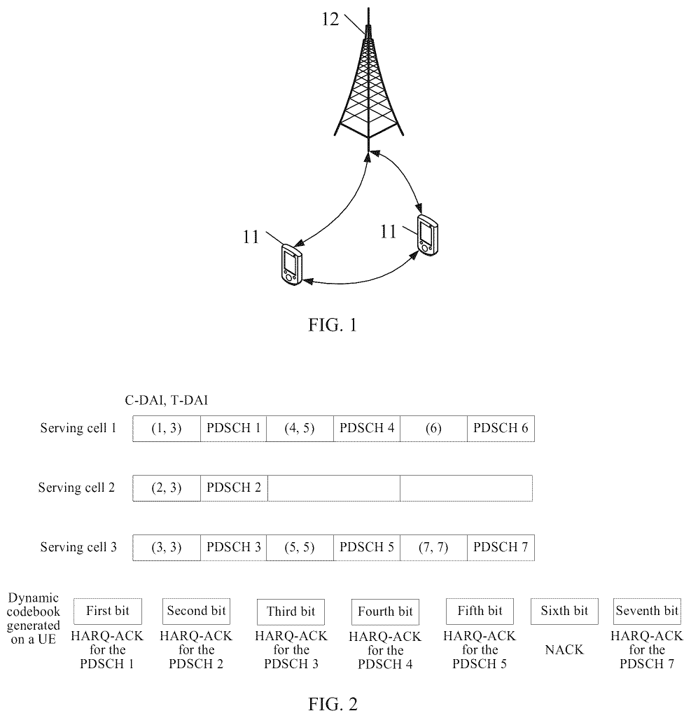

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer which is also referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a vehicle user equipment (VUE), a pedestrian user equipment (PUE), a smart home device (a home device with wireless communication functionality, for example, a refrigerator, a TV, a washing machine, or furniture), a game console, a personal computer (PC), a teller machine, or a self-service machine. The wearable device includes a smart watch, a smart band, smart earphones, smart glasses, smart jewelry (a smart bracelet, a smart hand chain, a smart ring, a smart necklace, a smart anklet, a smart foot chain, and the like), a smart wristband, smart clothes, and the like. It should be noted that a type of the terminal 11 is not limited in this embodiment of this application. The network-side device 12 may include an access network device or a core network device. The access network device 12 may also be referred to as a radio access network device, a radio access network (RAN), a radio access network function, or a radio access network unit. The access network device 12 may include a base station, a WLAN access point, a Wi-Fi node, or the like. A base station may be referred to as a NodeB (NB), an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. The base station is not limited to a particular technical term, provided that same technical effects are achieved. It should be noted that in this embodiment of this application, only the base station in the NR system is used as an example for description, but a type of the base station is not limited. With reference to the accompanying drawings and by using some embodiments and their application scenarios, the following describes in detail DCI processing methods provided in embodiments of this application.

Currently, when a UE organizes a hybrid automatic repeat request-acknowledgement (HARQ-ACK) bit sequence that needs to be reported at a specific feedback timing, the UE determines, according to a predefined rule and based on scheduling of physical downlink shared channel (PDSCH) transmissions for which HARQ-ACK needs to be reported at the feedback timing and that are on a single carrier/a plurality of carriers, a mapping between each PDSCH transmission and a bit/bits in the organized HARQ-ACK bit sequence. The operation is referred to as constructing a HARQ-ACK codebook. When an SPS PDSCH release is indicated by DCI, the UE also needs to acknowledge a reception of the DCI with a HARQ-ACK bit, to ensure that two sides have consistent understandings of whether an SPS PDSCH is in an activated state.

For example, in a case that at least one of cells that are scheduled jointly with DCI is in a deactivated state, or at least one of the cells is in a BWP dormancy state, or at least one symbol of one of the cells conflicts with an uplink symbol in a TDD configuration, a behavior of receiving or decoding the DCI and scheduled downlink transmissions is not determined.

Currently, NR Re-15 uses two HARQ-ACK codebook solutions: a semi-static codebook (Type-1) and a dynamic codebook (Type-2). For the type-1 solution, a feedback is provided for all possible DCI indications and PDSCH transmissions. The type-1 solution is mainly used to ensure reliability of transmission, and feedback overheads are high. For the type-2 solution, a feedback is provided only for actual DCI indications and PDSCH transmissions. Therefore, feedback overheads are low. However, when missed DCI detection is common, reliability of transmission is affected to some extent.

However, a size of the HARQ-ACK semi-static codebook is not related to actual scheduling, but is determined by an RRC configuration or a predefined parameter. When an RRC parameter pdsch-HARQ-ACK-Codebook is set to semi-static, the semi-static codebook is configured.

It should be noted that for the semi-static codebook, a set of occasions for candidate PDSCH receptions needs to be determined, that is, for a specified actual unit for HARQ-ACK feedback (slot n), a set of an activated downlink BWP, an activated uplink BWP, and all downlink data requiring HARQ-ACK feedbacks in each corresponding serving cell. If the cell is in a deactivated state, the UE uses, as an activated downlink BWP, a BWP configured by using an RRC parameter firstActiveDownlinkBWP-Id.

For the dynamic codebook, a DAI is used to count actually scheduled PDSCH transmissions/SPS PDSCH release indications, and HARQ-ACK feedback bits are reserved for each DAI value actually used. Therefore, if the UE infers, based on another detected DAI, that PDSCH assignment indications or SPS PDSCH release indications corresponding to some DAIs are not received, the UE sets corresponding feedback bits to NACK. Otherwise, the UE sets corresponding HARQ-ACK feedback bits based on results of decoding PDSCH transmissions corresponding to PDSCH assignment indications. For a detected SPS PDSCH release indication, the UE sets a corresponding feedback bit to ACK.

FIG. 2 is a diagram of a dynamic codebook according to an embodiment of this application. As shown in FIG. 2, in a first physical downlink control channel (PDCCH) monitoring occasion, C-DAIs on serving cells 1, 2, and 3 are 1, 2, and 3, respectively, and values of T-DAIs on the serving cells are all 3. Each DAI corresponds to one {PDCCH monitoring occasion, scheduled serving cell identity (serving cell id)}. It can be learned based on the figure above that DCI for a scheduled PDSCH 6 is not detected, and therefore, NACK is stuffed at a sixth position when the dynamic codebook is generated.

Currently, in research on R18, for a purpose of reducing signaling overheads, a feature of scheduling physical uplink shared channels (PUSCHs) or PDSCHs on a plurality of cells with single DCI (each cell has one PUSCH or PDSCH) is introduced. In addition, in a case that a plurality of cells are scheduled with single DCI, a “scheduled serving cell id” used to determine a DAI is a minimum ID of the cells that are scheduled jointly with the DCI.

A maximum HARQ-ACK bit quantity corresponding to each DCI format 1-X with which a plurality of cells are scheduled jointly in a type-2 codebook may be determined according to the following rule.

A group includes cells that can be scheduled jointly with DCI format 1-X. In a case that two codewords are configured for at least one of the cells in the group but space division multiplexing is not configured for the cell, and more than one cell is scheduled with DCI format 1-X, a UE's HARQ-ACK bit quantity that corresponds to these DCI formats 1-X in the PUCCH group is M, where M is a maximum quantity of TBs that can be scheduled with DCI format 1-X. Otherwise, the UE's HARQ-ACK bit quantity that corresponds to each DCI format 1-X in the PUCCH group is N, where N is a maximum quantity of cells that can be scheduled jointly with DCI format 1-X by the UE in the PUCCH group.

A cell may enter an activated/deactivated state by delivering radio resource control (RRC) signaling or by activating/deactivating the Scell by a MAC CE. BWP dormancy may be implemented as follows: configuring a dormant BWP by using RRC, and using an Scell dormancy indication field in DCI to indicate an Scell to switch to the dormant BWP or to another specified BWP. In a case that a cell is in a deactivated state or a BWP dormancy state, a UE cannot monitor a PDCCH or receive or send data in the cell.

Therefore, in a case that at least one symbol of a PDSCH conflicts with an uplink symbol in a TDD configuration, or a cell on which a PDSCH is located is in the deactivated state or the BWP dormancy state, PDSCHs of this category may be collectively referred to as invalid PDSCHs.

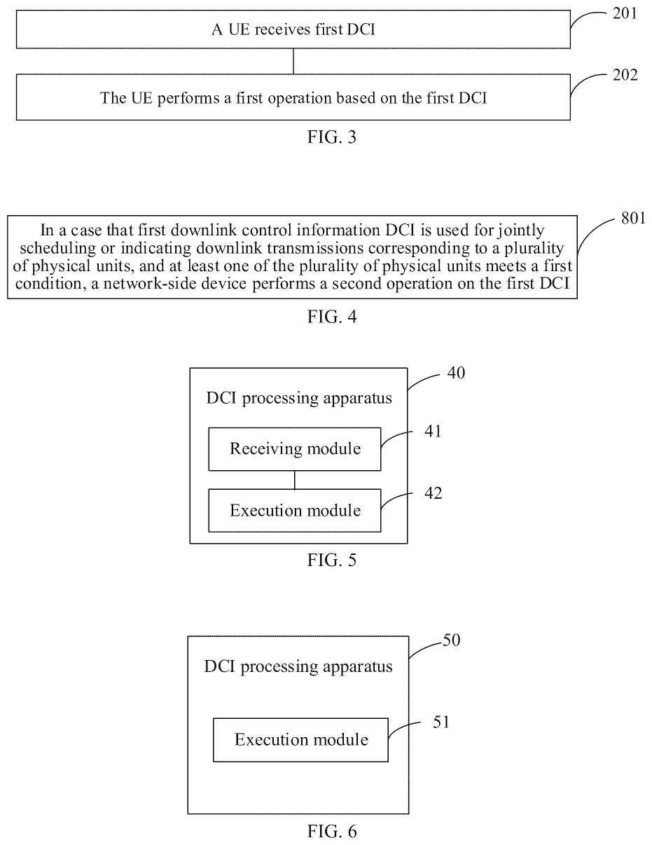

An embodiment of this application provides a DCI processing method, which is applied to a UE. FIG. 3 is a flowchart of the DCI processing method according to the embodiment of this application. As shown in FIG. 3, the DCI processing method provided in this embodiment of this application may include step 201 and step 202 below.

Step 201: A UE receives first DCI.

In this embodiment of this application, the first DCI is used for jointly scheduling or indicating downlink transmissions corresponding to a plurality of physical units, and at least one first physical unit of the plurality of physical units meets a first condition.

In this embodiment of this application, in a case that the first DCI is used for jointly scheduling or indicating downlink transmissions corresponding to a plurality of physical units, and at least one first physical unit of the plurality of physical units meets the first condition, the UE receives the first DCI sent by a network-side device.

In this embodiment of this application, the physical unit may be any one of the following: a cell, a BWP, or a resource pool.

In this embodiment of this application, the first condition includes at least one of the following:
a physical unit is in a deactivated state;
a physical unit is in a BWP dormancy state; or
at least one symbol of a downlink transmission corresponding to a physical unit conflicts with an uplink symbol configured by the network-side device.

Step 202: The UE performs a first operation based on the first DCI.

The first operation includes at least one of the following:
not receiving or not decoding the downlink transmission corresponding to the first physical unit.

In this embodiment of this application, the UE may not receive or not decode, based on the first DCI, a PDSCH corresponding to the first physical unit.

According to the DCI processing method provided in this embodiment of this application, in a case that the first DCI is used for jointly scheduling or indicating the downlink transmissions corresponding to the plurality of physical units, and at least one first physical unit of the plurality of physical units meets the first condition, if the UE receives the first DCI, the UE may determine, based on the first DCI, a manner of providing a feedback for the first DCI, that is, determine not to receive or not to decode the downlink transmission corresponding to the first physical unit. Therefore, while flexibility of joint scheduling or indicating with the first DCI is ensured, the UE can determine a behavior of receiving or decoding the first DCI and scheduled downlink transmissions.

Optionally, after step 201, the DCI processing method provided in this embodiment of this application further includes step 301 below.

Step 301: In a case that each of the physical units that are scheduled jointly with the first DCI meets the first condition, the UE performs a first operation according to a first rule.

The first operation includes at least one of the following:
deactivating, by the UE, joint scheduling of the plurality of physical units;
not performing, by the UE, blind detection for second DCI;
not monitoring, by the UE, second DCI; or
adjusting, by the UE, a blind detection budget corresponding to second DCI to a preset value.

The second DCI is DCI to be received after the UE receives the first DCI, the second DCI is used for jointly scheduling or indicating downlink transmissions corresponding to a plurality of physical units, and at least one second physical unit of the plurality of physical units meets the first condition.

Optionally, in this embodiment of this application, the preset value may be 0.

Optionally, in this embodiment of this application, in a case that each of the physical units that are scheduled jointly with the first DCI meets the first condition, the first DCI may be interpreted as at least one of the following meanings:
deactivating joint scheduling of the plurality of physical units;
not performing blind detection for the second DCI;
not monitoring the second DCI; or
adjusting the blind detection budget corresponding to the second DCI to the preset value (for example, 0).

Optionally, the “not receiving or not decoding the downlink transmission corresponding to the first physical unit” in step 202 may be implemented by step 202a below.

Step 202a: The UE ignores transmission information of the first physical unit.

Optionally, in this embodiment of this application, the first DCI includes a first bit field, and step 202a may be implemented by any one of step 11 to step 14 below.

Step 11: In a case that the first bit field indicates only the transmission information of the first physical unit, the UE ignores the first bit field.

Step 12: The UE ignores, based on a type of the first bit field, the transmission information of the first physical unit indicated by the first bit field.

Step 13: In a case that the first bit field indicates both the transmission information of the first physical unit and transmission information of a third physical unit, the UE ignores the transmission information of the first physical unit indicated by the first bit field, where the third physical unit is different from the first physical unit.

Step 14: In a case that the first bit field indicates both the transmission information of the first physical unit and transmission information of a third physical unit, and if the first physical unit and the third physical unit have same transmission information, the UE does not apply the same transmission information in the first physical unit.

Optionally, the first bit field may include a modulation and coding status (MCS) field, a redundancy version (RV) field, a HARQ process number field, a new data indicator (NDI) field, and a time domain resource assignment (TDRA) field.

For example, if the NDI and RV are indicated for each of the plurality of physical units, the UE ignores an NDI and an RV that are indicated for the first physical unit.

For example, if the MCS is indicated for all the plurality of physical units, the UE ignores an indication that is for the first physical unit in the first DCI.

For example, if the TDRA is indicated for the plurality of physical units together, the UE ignores an indication that is for the first physical unit in a combined indication.

Optionally, in this embodiment of this application, the first DCI includes a first bit field, and the DCI processing method further includes step 401 or step 402 below.

Step 401: In a case that the first bit field indicates only the transmission information of the first physical unit, the UE performs DCI function verification based on an indication by the first bit field.

Optionally, in this embodiment of this application, the DCI function verification includes: deactivating joint scheduling of the first physical unit with other physical units.

Step 402: The UE performs DCI function verification based on type information of the first bit field.

Optionally, after step 201, the DCI processing method provided in this embodiment of this application further includes step 501 below.

Step 501: The UE determines a corresponding HARQ-ACK codebook based on the first DCI.

Optionally, in this embodiment of this application, after determining the corresponding HARQ-ACK codebook based on the first DCI, the UE may feed back the corresponding HARQ-ACK codebook to the network-side device.

In this embodiment of this application, after the UE receives the first DCI, in a case that at least one of cells that are scheduled jointly with the first DCI is in the deactivated state, or at least one of the cells is in the BWP dormancy state, or at least one symbol of one of the cells conflicts with an uplink symbol in a TDD configuration, the UE may perform a corresponding operation and generate a corresponding HARQ-ACK codebook based on an interpretation of the first DCI. Therefore, while flexibility of joint scheduling with the first DCI is improved, the UE and the network-side device can have consistent understandings of codebook feedback.

Optionally, step 501 may be implemented by step 501a below.

Step 501a: The UE generates HARQ bits corresponding to the first physical unit at a bit position corresponding to the first physical unit in the HARQ-ACK codebook.

Optionally, step 501a may be implemented by step 21 or step 22 below.

Step 21: In a case that two codewords are configured for the first physical unit but space division multiplexing is not configured for the first physical unit, the UE sets the HARQ bits corresponding to the first physical unit to a first preset quantity of ACKs or the first preset quantity of NACKs at the bit position corresponding to the first physical unit in the HARQ-ACK codebook.

Optionally, in this embodiment of this application, in a case that the first physical unit meets a first specific condition in the first condition, and in a case that two codewords are configured for the first physical unit but space division multiplexing is not configured for the first physical unit, the UE sets the HARQ bits corresponding to the first physical unit to two ACKs or two NACKs at the bit position corresponding to the first physical unit in the HARQ-ACK codebook.

Optionally, in this embodiment of this application, in a case that feedback by using a type-2 HARQ-ACK codebook is configured for the UE, if two codewords are configured for the first physical unit but space division multiplexing is not configured for the first physical unit, two NACKs are fed back.

For example, if the first physical unit is in the deactivated state or the BWP dormancy state, the UE feeds back one NACK. If at least one symbol of a PDSCH corresponding to the first physical unit conflicts with an uplink symbol configured by the network-side device, the UE feeds back two NACKs.

Optionally, in this embodiment of this application, in a case that the first physical unit meets a first specific condition in the first condition, and in a case that two codewords are configured for the first physical unit but space division multiplexing is not configured for the first physical unit, the UE sets the HARQ bits corresponding to the first physical unit to one ACK or one NACK at the bit position corresponding to the first physical unit in the HARQ-ACK codebook.

Optionally, in this embodiment of this application, the first specific condition may include at least one of the following:
a physical unit is in the deactivated state; or
a physical unit is in the bandwidth part BWP dormancy state.

Step 22: In a case that neither two codewords nor space division multiplexing is configured for the first physical unit, the UE sets the HARQ bits corresponding to the first physical unit to a second preset quantity of NACKs or the second preset quantity of ACKs at the bit position corresponding to the first physical unit in the HARQ-ACK codebook.

Optionally, in this embodiment of this application, in a case that the first physical unit meets a second specific condition in the first condition, and in a case that neither two codewords nor space division multiplexing is configured for the first physical unit, the UE sets the HARQ bits corresponding to the first physical unit to one ACK or one NACK at the bit position corresponding to the first physical unit in the HARQ-ACK codebook.

Optionally, in this embodiment of this application, the second specific condition may include: At least one symbol of a downlink transmission corresponding to a physical unit conflicts with an uplink symbol configured by the network-side device.

Optionally, in this embodiment of this application, the bit position corresponding to the first physical unit in the HARQ-ACK codebook is determined based on any one of the following:
order information of physical units in a combination of the plurality of physical units that are scheduled jointly with the first DCI, where
for example, if three cells are scheduled jointly with the first DCI, and the three cells are combined in an order of 5,2,3, a feedback may be provided in an order of the cell 5, the cell 2, and the cell 3;
order information of indices of physical units in a combination of the plurality of physical units that are scheduled jointly with the first DCI, where
for example, if three cells are scheduled jointly with the first DCI, and the three cells are combined in an order of 5,2,3, a feedback may be provided in an order of the cell 2, the cell 3, and the cell 5 or in an order of the cell 5, the cell 3, and the cell 2;
first based on order information of physical units in a combination of the plurality of physical units that are scheduled jointly with the first DCI, and then based on order information of transport blocks in the plurality of physical units that are scheduled jointly with the first DCI, where
for example, if three cells are scheduled jointly with the first DCI, and the three cells are combined in an order of 5,2,3, where two codewords are configured for the cell 2 but space division multiplexing is not configured for the cell 2, and one codeword is configured for the cell 3 and the cell 5, a feedback may be provided in an order of the cell 5, the cell 2 (TB 1), the cell 2 (TB 2), and the cell 3;
first based on order information of transport blocks in the plurality of physical units that are scheduled jointly with the first DCI, and then based on order information of the plurality of physical units that are scheduled jointly with the first DCI, where
for example, if three cells are scheduled jointly with the first DCI, and the three cells are combined in an order of 5,2,3, where two codewords are configured for the cell 2 but space division multiplexing is not configured for the cell 2, a feedback may be provided in an order of the cell 5, the cell 2 (TB 1), the cell 3, and the cell 2 (TB 2);
first based on order information of indices of physical units in a combination of the plurality of physical units that are scheduled jointly with the first DCI, and then based on order information of transport blocks in the plurality of physical units that are scheduled jointly with the first DCI, where
for example, if three cells are scheduled jointly with the first DCI, and the three cells are combined in an order of 5,2,3, where two codewords are configured for the cell 2 but space division multiplexing is not configured for the cell 2, a feedback may be provided in an order of the cell 2 (TB 1), the cell 2 (TB 2), the cell 3, and the cell 5 or in an order of the cell 5, the cell 3, and the cell 2 (TB 1, TB 2); or
first based on order information of transport blocks in the plurality of physical units that are scheduled jointly with the first DCI, and then based on order information of indices of physical units in the plurality of physical units that are scheduled jointly with the first DCI, where
for example, if three cells are scheduled jointly with the first DCI, and the three cells are combined in an order of 5,2,3, where two codewords are configured for the cell 2 but space division multiplexing is not configured for the cell 2, a feedback may be provided in an order of the cell 2 (TB 1), the cell 3, the cell 5, and the cell 2 (TB 2).

Optionally, in this embodiment of this application, different bit positions correspond to different conditions in the first condition, respectively.

For example, in a case that the first physical unit is in the deactivated state, or a BWP is in a dormancy state, the bit position may be determined first based on order information of cells and then based on order information of TBs.

For example, in a case that at least one symbol of a PDSCH corresponding to the first physical unit conflicts with an uplink symbol configured by the network-side device, the bit position is determined based on the order information of the indices of the physical units in the combination of the plurality of physical units that are scheduled jointly with the first DCI.

Optionally, the DCI processing method provided in this embodiment of this application further includes step 601 below.

Step 601: In a case that each of the plurality of physical units meets the first condition, the UE does not generate bits corresponding to the first DCI in a HARQ-ACK codebook corresponding to the first DCI.

Optionally, after step 201, the DCI processing method provided in this embodiment of this application further includes step 701 below.

Step 701: In a case that a quantity X of valid HARQ-ACK bits corresponding to the first DCI is less than a quantity Y of bits in a HARQ-ACK codebook actually fed back by the first DCI, the UE stuffs a first bit.

In this embodiment of this application, a quantity of the first bits is a difference between Y and X.

In this embodiment of this application, if a NACK is fed back for each actually transmitted PDSCH but the stuffed bit feeds back an ACK, the network-side device can learn that the UE receives the first DCI, helping the network-side device distinguish between a total transmission failure and a DCI loss.

Optionally, that “the UE stuffs the first bit” in step 701 may be implemented by step 701a or step 701b below.

Step 701a: The UE stuffs the first bit before an X-th bit of the valid HARQ-ACK bits corresponding to the first DCI.

Step 701b: The UE stuffs the first bit after an X-th bit of the valid HARQ-ACK bits corresponding to the first DCI.

Optionally, that “the UE stuffs the first bit” in step 701 may be implemented by step 701c below.

Step 701c: The UE stuffs the first bit as an ACK.

An embodiment of this application provides a DCI processing method, which is applied to a network-side device. FIG. 4 is a flowchart of the DCI processing method according to the embodiment of this application. As shown in FIG. 4, the DCI processing method provided in this embodiment of this application may include step 801 below.

Step 801: In a case that first downlink control information DCI is used for jointly scheduling or indicating downlink transmissions corresponding to a plurality of physical units, and at least one of the plurality of physical units meets a first condition, a network-side device performs a second operation on the first DCI.

The second operation includes sending the first DCI to a user equipment UE or not sending the first DCI to a UE.

Optionally, in this embodiment of this application, the first condition includes at least one of the following: A physical unit is in a deactivated state; a physical unit is in a bandwidth part BWP dormancy state; or at least one symbol of a downlink transmission corresponding to a physical unit conflicts with an uplink symbol configured by the network-side device.

Optionally, in this embodiment of this application, the second operation is not sending the first DCI to the UE, and that “the network side performs the second operation on the first DCI in a case that at least one of the plurality of physical units meets the first condition” in step 801 may be implemented by at least one of the following steps:

Step 801a: In a case that each of the plurality of physical units meets the first condition, the network-side device does not send the first DCI to the UE.

Step 801b: In a case that a predefined quantity of physical units do not meet the first condition, the network-side device does not send the first DCI to the UE.

Optionally, in this embodiment of this application, the second operation is sending the first DCI to the UE, and the DCI processing method provided in this embodiment of this application further includes step 901 or step 902 below.

Step 901: In a case that at least one of the plurality of physical units does not meet the first condition, the network side sends the first DCI to the UE.

Step 902: In a case that a predefined quantity of physical units of the plurality of physical units do not meet the first condition, the network side sends the first DCI to the UE.

Optionally, in this embodiment of this application, the predefined quantity of physical units are all the physical units that are scheduled or indicated jointly with the first DCI.

According to the DCI processing method provided in this embodiment of this application, in a case that the first downlink control information DCI is used for jointly scheduling or indicating the downlink transmissions corresponding to the plurality of physical units, and at least one of the plurality of physical units meets the first condition, the second operation is performed on the first DCI, that is, sending the first DCI or not sending the first DCI. Therefore, flexibility of joint processing with the first DCI by the network-side device is improved.

The DCI processing method provided in the embodiment of this application may be performed by a DCI processing apparatus. In an embodiment of this application, a DCI processing apparatus provided in the embodiment of this application is described by using an example in which the DCI processing apparatus performs the DCI processing method.

FIG. 5 is a diagram of a possible structure of a DCI processing apparatus according to an embodiment of this application. As shown in FIG. 5, the DCI processing apparatus 40 may include a receiving module 41 and an execution module 42.

The receiving module 41 is configured to: receive first DCI, where the first DCI is used for jointly scheduling or indicating downlink transmissions corresponding to a plurality of physical units, and at least one first physical unit of the plurality of physical units meets a first condition. The execution module 42 is configured to: perform a first operation based on the first DCI, where the first operation includes at least one of the following: not receiving or not decoding the downlink transmission corresponding to the first physical unit.

According to the DCI processing apparatus provided in this embodiment of this application, in a case that the first DCI is used for jointly scheduling or indicating the downlink transmissions corresponding to the plurality of physical units, and at least one first physical unit of the plurality of physical units meets the first condition, if the DCI processing apparatus receives the first DCI, the DCI processing apparatus may determine, based on the first DCI, a manner of providing a feedback for the first DCI, that is, determine not to receive or not to decode the downlink transmission corresponding to the first physical unit. Therefore, while flexibility of joint scheduling or indicating with the first DCI is ensured, the DCI processing apparatus can determine a behavior of receiving or decoding the first DCI and scheduled downlink transmissions.

FIG. 6 is a diagram of a possible structure of a DCI processing apparatus according to an embodiment of this application. As shown in FIG. 6, the DCI processing apparatus 50 may include an execution module 51.

The execution module 51 is configured to: in a case that first downlink control information DCI is used for jointly scheduling or indicating downlink transmissions corresponding to a plurality of physical units, and at least one of the plurality of physical units meets a first condition, perform a second operation on the first DCI, where the second operation includes sending the first DCI to a user equipment UE or not sending the first DCI to a UE.

According to the DCI processing apparatus provided in this embodiment of this application, in a case that the first downlink control information DCI is used for jointly scheduling or indicating the downlink transmissions corresponding to the plurality of physical units, and at least one of the plurality of physical units meets the first condition, the second operation is performed on the first DCI, that is, sending the first DCI or not sending the first DCI. Therefore, flexibility of joint processing with the first DCI by the network-side device is improved.

The DCI processing apparatus in embodiments of this application may be an electronic device, for example, an electronic device with an operating system, or may be a component in an electronic device, for example, an integrated circuit or a chip. The electronic device may be a terminal, or may be another device other than a terminal. For example, a terminal may be of but is not limited to the types of the terminal 11 listed above, and another device may be a server, a network attached storage (NAS), or the like. This is not limited in embodiments of this application.

The DCI processing apparatus provided in embodiments of this application can perform the procedures implemented in the foregoing method embodiments and achieve same technical effects. To avoid repetition, details are not described herein again.

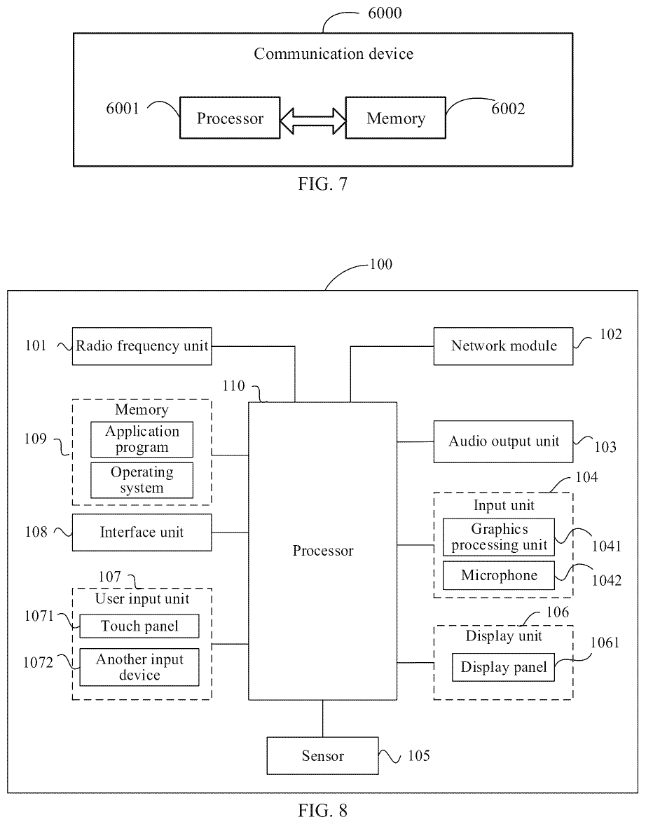

Optionally, as shown in FIG. 7, an embodiment of this application further provides a communication device 6000, including a processor 6001 and a memory 6002. The memory 6002 stores a program or instructions are executable on the processor 6001. For example, in a case that the communication device 6000 is a terminal, when the program or instructions are executed by the processor 6001, the steps of the DCI processing method embodiment are performed, and same technical effects can be achieved. In a case that the communication device 6000 is a network-side device, when the program or instructions are executed by the processor 6001, the steps of the DCI processing method embodiment are performed, and same technical effects can be achieved. To avoid repetition, details are not described herein again.

An embodiment of this application further provides a UE, including a processor and a communication interface. This UE embodiment corresponds to the method embodiment on a UE side. The implementation procedures and implementations in the method embodiment may all be applicable to this UE embodiment, and same technical effects can be achieved. Optionally, FIG. 8 is a diagram of a hardware structure of a UE that implements an embodiment of this application.

The UE 100 includes, but is not limited to, at least some of a radio frequency unit 101, a network module 102, an audio output unit 103, an input unit 104, a sensor 105, a display unit 106, a user input unit 107, an interface unit 108, a memory 109, a processor 110, and the like.

Persons skilled in the art may understand that the UE 100 may further include a power supply (such as a battery) that supplies power to the components. The power supply may be logically connected to the processor 110 by a power management system, implementing functions such as charging, discharging, and power consumption management by using the power management system. The structure of the UE shown in FIG. 8 does not constitute a limitation on the UE. A UE may include more or fewer components than those shown in the figure, or combine some components, or have different component arrangements. Details are not described herein.

It should be understood that the input unit 104 may include a graphics processing unit (GPU) 1041 and a microphone 1042 in this embodiment of this application. The GPU 1041 processes image data of still pictures or videos that are obtained by image capture apparatuses (for example, cameras) in video capture mode or image capture mode. The display unit 106 may include a display panel 1061. The display panel 1061 may be configured in a form of a liquid crystal display, an organic light-emitting diode, or the like. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include, but is not limited to, a physical keyboard, a functional button (such as a volume control button or a switch button), a trackball, a mouse, or a joystick. Details are not described herein.

In this embodiment of this application, after receiving downlink data from a network-side device, the radio frequency unit 101 may transmit the data to the processor 110 for processing. In addition, the radio frequency unit 101 may send uplink data to a network-side device. Usually, the radio frequency unit 101 includes, but is not limited to, an antenna, an amplifier, a transceiver, a coupler, a low noise amplifier, a duplexer, and the like.

The memory 109 may be configured to store software programs or instructions, and various data. The memory 109 may mainly include a first storage area in which programs or instructions are stored and a second storage area in which data is stored. In the first storage area, the following may be stored: an operating system, application programs or instructions required by at least one function (for example, a sound playing function or an image display function), and the like. In addition, the memory 109 may include a volatile memory or a non-volatile memory, or may include both a volatile memory and a non-volatile memory. A non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. A volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), or a direct rambus random access memory (Direct Rambus RAM, DRRAM). The memory 109 in this embodiment of this application includes, but is not limited to, these memories and any other suitable types of memories.

The processor 110 may include one or more processing units. Optionally, an application processor and a modem processor integrate with the processor 110. The application processor primarily handles operations related to an operating system, user interfaces, application programs, and the like. The modem processor primarily processes wireless communication signals, for example, a baseband processor. It may be understood that the modem processor may alternatively not be integrated into the processor 110.

The processor 110 is configured to: receive first DCI, where the first DCI is used for jointly scheduling or indicating downlink transmissions corresponding to a plurality of physical units, and at least one first physical unit of the plurality of physical units meets a first condition; and perform a first operation based on the first DCI, where the first operation includes at least one of the following: not receiving or not decoding the downlink transmission corresponding to the first physical unit.

According to the UE provided in this embodiment of this application, in a case that the first DCI is used for jointly scheduling or indicating the downlink transmissions corresponding to the plurality of physical units, and at least one first physical unit of the plurality of physical units meets the first condition, if the UE receives the first DCI, the UE may determine, based on the first DCI, a manner of providing a feedback for the first DCI, that is, determine not to receive or not to decode the downlink transmission corresponding to the first physical unit. Therefore, while flexibility of joint scheduling or indicating with the first DCI is ensured, the UE can determine a behavior of receiving or decoding the first DCI and scheduled downlink transmissions.

An embodiment of this application further provides a network-side device, including a processor and a communication interface. This network-side device embodiment corresponds to the network-side device method embodiment. The implementation procedures and implementations in the method embodiment may all be applicable to this network-side device embodiment, and same technical effects can be achieved.

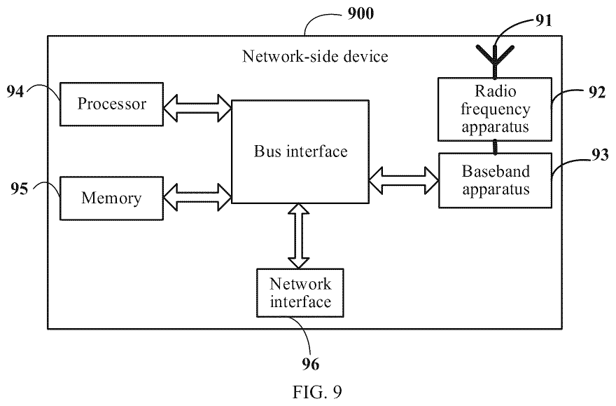

Optionally, an embodiment of this application further provides a network-side device. As shown in FIG. 9, the network-side device 900 includes: an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information by using the antenna 91 and sends the received information to the baseband apparatus 93 for processing. In a downlink direction, the baseband apparatus 93 processes to-be-sent information and sends processed information to the radio frequency apparatus 92. The radio frequency apparatus 92 receives and processes the information, and sends out processed information by using the antenna 91.

The method performed by the network-side device in the foregoing embodiments may be implemented in the baseband apparatus 93. The baseband apparatus 93 includes a baseband processor.

The baseband apparatus 93 may include, for example, at least one baseband board. A plurality of chips are disposed on the baseband board. As shown in FIG. 9, one of the chips, for example, a baseband processor, is connected to the memory 95 by using a bus interface, to invoke a program in the memory 95 to perform the network device operations shown in the foregoing method embodiments.

The network-side device may further include a network interface 96. The interface is, for example, a common public radio interface (CPRI).

Optionally, the network-side device 900 in this embodiment of the present application further includes instructions or a program that are or is stored in the memory 95 and executable on the processor 94. The processor 94 invokes the instructions or program in the memory 95 to perform the method performed by the modules shown in FIG. 8, and achieves same technical effects. To avoid repetition, details are not described herein again.

The processor 94 is configured to: in a case that first downlink control information DCI is used for jointly scheduling or indicating downlink transmissions corresponding to a plurality of physical units, and at least one of the plurality of physical units meets a first condition, perform a second operation on the first DCI, where the second operation includes sending the first DCI to a user equipment UE or not sending the first DCI to a UE.

According to the network-side device provided in this embodiment of this application, in a case that the first downlink control information DCI is used for jointly scheduling or indicating the downlink transmissions corresponding to the plurality of physical units, and at least one of the plurality of physical units meets the first condition, the second operation is performed on the first DCI, that is, sending the first DCI or not sending the first DCI. Therefore, flexibility of joint processing with the first DCI by the network-side device is improved.

An embodiment of this application further provides a non-transitory readable storage medium. The non-transitory readable storage medium stores a program or instructions. When the program or instructions are executed by a processor, the procedures in the foregoing DCI processing method embodiments are performed, and same technical effects can be achieved. To avoid repetition, details are not described herein again.

The processor is the processor in the terminal in the foregoing embodiment. The non-transitory readable storage medium includes a non-transitory computer-readable storage medium, for example, a computer read-only memory ROM, a random access memory RAM, a magnetic disk, or a compact disc.

An embodiment of this application further provides a chip. The chip includes a processor and a communication interface. The communication interface is coupled to the processor. The processor is configured to run a program or instructions to implement the procedures in the foregoing DCI processing method embodiments, and can achieve same technical effects. To avoid repetition, details are not described herein again.

It should be understood that the chip mentioned in this embodiment of this application may also be referred to as a system-level chip, a system chip, a chip system, a system-on-chip chip, or the like.

An embodiment of this application further provides a computer program/program product. The computer program/program product is stored in a non-transitory storage medium. The computer program/program product is executed by at least one processor to implement the procedures in the foregoing DCI processing method embodiments, and same technical effects can be achieved. To avoid repetition, details are not described herein again.

An embodiment of this application further provides a DCI processing system, including a UE and a network-side device. The UE may be used to perform the steps in the DCI processing method described above. The network-side device may be used to perform the steps in the DCI processing method described above.

It should be noted that the term “include”, “comprise”, or any other variant thereof in this specification is intended to cover a non-exclusive inclusion, so that a process, a method, an object, or an apparatus that includes a list of elements not only includes those elements but also includes other elements that are not explicitly listed, or further includes elements inherent to such process, method, object, or apparatus. In absence of more constraints, an element preceded by “includes a . . . ” does not preclude existence of other identical elements in the process, method, object, or apparatus that includes the element. In addition, it should be noted that in the scope of the methods and apparatuses in implementations of this application, an order in which functions are performed is not limited to the shown or discussed order, and may further include an order in which the functions are substantially performed at the same time or a reverse order, depending on the functions related to. For example, the methods described may be performed in different orders than the described orders, and steps may be added, omitted, or combined. In addition, features described with reference to some examples may be combined in other examples.

Based on the descriptions in the foregoing implementations, persons skilled in the art may clearly learn that the methods in the foregoing embodiments may be implemented by a combination of software and a mandatory common hardware platform. Certainly, the methods may be alternatively implemented by hardware. Based on such an understanding, the technical solutions of this application essentially or the part contributing to the conventional technology may be implemented in a form of a computer software product. The computer software product is stored in a storage medium (for example, a ROM/RAM, a magnetic disk, or a compact disc), and includes several instructions for indicating a terminal (which may be a mobile phone, a computer, a server, an air conditioner, a network device, or the like) to perform the methods described in embodiments of this application.

Embodiments of this application are described above with reference to the accompanying drawings. However, this application is not limited to the implementations described above, and the implementations described above are merely illustrative but not restrictive. Under inspiration of this application, persons of ordinary skill in the art may also make many variations without departing from the purpose of this application and the protection scope of the claims, and such variations all fall within the protection scope of this application.

What is claimed is:

1. A downlink control information (DCI) processing method, wherein the method comprises:
receiving, by a user equipment (UE), first DCI, wherein the first DCI is used for jointly scheduling or indicating downlink transmissions corresponding to a plurality of physical units, and at least one first physical unit of the plurality of physical units meets a first condition; and
performing, by the UE, a first operation based on the first DCI, wherein the first operation comprises at least one of the following:
not receiving or not decoding the downlink transmission corresponding to the first physical unit.

2. The method according to claim 1, wherein the first condition comprises at least one of the following:
a physical unit is in a deactivated state;
a physical unit is in a bandwidth part (BWP) dormancy state; or
at least one symbol of a downlink transmission corresponding to a physical unit conflicts with an uplink symbol configured by a network-side device.

3. The method according to claim 1, wherein after the receiving, by the UE, the first DCI, the method further comprises:
in a case that each of the physical units that are scheduled jointly with the first DCI meets the first condition, performing, by the UE, a first operation according to a first rule, wherein
the first operation comprises at least one of the following:
deactivating, by the UE, joint scheduling of the plurality of physical units;
not performing, by the UE, blind detection for second DCI;
not monitoring, by the UE, second DCI; or
adjusting, by the UE, a blind detection budget corresponding to second DCI to a preset value, wherein
the second DCI is DCI to be received after the UE receives the first DCI, the second DCI is used for jointly scheduling or indicating downlink transmissions corresponding to a plurality of physical units, and at least one second physical unit of the plurality of physical units meets the first condition.

4. The method according to claim 1, wherein the not receiving or not decoding the downlink transmission corresponding to the first physical unit comprises:
ignoring, by the UE, transmission information of the first physical unit;
wherein the first DCI comprises a first bit field; and
the ignoring, by the UE, the transmission information of the first physical unit comprises any one of the following:
in a case that the first bit field indicates only the transmission information of the first physical unit, ignoring, by the UE, the first bit field;
ignoring, by the UE based on a type of the first bit field, the transmission information of the first physical unit indicated by the first bit field;
in a case that the first bit field indicates both the transmission information of the first physical unit and transmission information of a third physical unit, ignoring, by the UE, the transmission information of the first physical unit indicated by the first bit field, wherein the third physical unit is different from the first physical unit; or
in a case that the first bit field indicates both the transmission information of the first physical unit and transmission information of a third physical unit, and if the first physical unit and the third physical unit have same transmission information, not applying, by the UE, the same transmission information in the first physical unit.

5. The method according to claim 1, wherein the first DCI comprises a first bit field, and the method further comprises:
in a case that the first bit field indicates only transmission information of the first physical unit, performing, by the UE, DCI function verification based on an indication by the first bit field;
or
performing, by the UE, DCI function verification based on type information of the first bit field.

6. The method according to claim 1, wherein after the receiving, by the UE, the first DCI, the method further comprises:
generating a hybrid automatic repeat request-acknowledgement (HARQ-ACK) codebook based on the first DCI, and generating HARQ bits corresponding to the first physical unit at a bit position corresponding to the first physical unit in the HARQ-ACK codebook.

7. The method according to claim 6, wherein the generating the HARQ bits corresponding to the first physical unit at the bit position corresponding to the first physical unit in the HARQ-ACK codebook comprises any one of the following:
in a case that two codewords are configured for the first physical unit but space division multiplexing is not configured for the first physical unit, setting, by the UE, the HARQ bits corresponding to the first physical unit to a first preset quantity of ACKs or the first preset quantity of NACKs at the bit position corresponding to the first physical unit in the HARQ-ACK codebook; or
in a case that neither two codewords nor space division multiplexing is configured for the first physical unit, setting the HARQ bits corresponding to the first physical unit to a second preset quantity of NACKs or the second preset quantity of ACKs at the bit position corresponding to the first physical unit in the HARQ-ACK codebook.

8. The method according to claim 6, wherein the bit position corresponding to the first physical unit in the HARQ-ACK codebook is determined based on any one of the following:
order information of physical units in a combination of the plurality of physical units that are scheduled jointly with the first DCI;
order information of indices of physical units in a combination of the plurality of physical units that are scheduled jointly with the first DCI;
first based on order information of physical units in a combination of the plurality of physical units that are scheduled jointly with the first DCI, and then based on order information of transport blocks in the plurality of physical units that are scheduled jointly with the first DCI;
first based on order information of transport blocks in the plurality of physical units that are scheduled jointly with the first DCI, and then based on order information of the plurality of physical units that are scheduled jointly with the first DCI;
first based on order information of indices of physical units in a combination of the plurality of physical units that are scheduled jointly with the first DCI, and then based on order information of transport blocks in the plurality of physical units that are scheduled jointly with the first DCI; or
first based on order information of transport blocks in the plurality of physical units that are scheduled jointly with the first DCI, and then based on order information of indices of physical units in the plurality of physical units that are scheduled jointly with the first DCI.

9. The method according to claim 8, wherein the bit position corresponding to the first physical unit in the HARQ-ACK codebook is determined based on a preset condition in the first condition.

10. The method according to claim 1, wherein the method further comprises:
in a case that each of the plurality of physical units meets the first condition, not generating, by the UE, bits corresponding to the first DCI in a hybrid automatic repeat request-acknowledgement (HARQ-ACK) codebook corresponding to the first DCI.

11. A downlink control information (DCI) processing method, wherein the method comprises:
in a case that first DCI is used for jointly scheduling or indicating downlink transmissions corresponding to a plurality of physical units, and at least one of the plurality of physical units meets a first condition, performing, by a network-side device, a second operation on the first DCI, wherein the second operation comprises sending the first DCI to a UE or not sending the first DCI to a user equipment (UE).

12. The method according to claim 11, wherein
the first condition comprises at least one of the following: a physical unit is in a deactivated state; a physical unit is in a bandwidth part (BWP) dormancy state; or at least one symbol of a downlink transmission corresponding to a physical unit conflicts with an uplink symbol configured by the network-side device.

13. The method according to claim 11, wherein
the second operation is not sending the first DCI to the UE, and the performing, by the network side device, the second operation on the first DCI in a case that at least one of the plurality of physical units meets the first condition comprises at least one of the following:
in a case that each of the plurality of physical units meets the first condition, not sending, by the network-side device, the first DCI to the UE; or
in a case that a predefined quantity of physical units do not meet the first condition, not sending, by the network-side device, the first DCI to the UE.

14. The method according to claim 11, wherein the second operation is sending the first DCI to the UE, and the method further comprises:
in a case that at least one of the plurality of physical units does not meet the first condition, sending, by the network side, the first DCI to the UE;
or
in a case that a predefined quantity of physical units of the plurality of physical units do not meet the first condition, sending, by the network side, the first DCI to the UE;
wherein
the predefined quantity of physical units are all the physical units that are scheduled or indicated jointly with the first DCI.

15. A user equipment (UE), comprising a processor and a memory, wherein the memory stores a program or instructions that are executable on the processor, and the program or instructions, when executed by the processor, cause the UE to perform:
receiving first downlink control information (DCI), wherein the first DCI is used for jointly scheduling or indicating downlink transmissions corresponding to a plurality of physical units, and at least one first physical unit of the plurality of physical units meets a first condition; and
performing a first operation based on the first DCI, wherein
the first operation comprises at least one of the following:
not receiving or not decoding the downlink transmission corresponding to the first physical unit.

16. The UE according to claim 15, wherein the first condition comprises at least one of the following:
a physical unit is in a deactivated state;
a physical unit is in a bandwidth part (BWP) dormancy state; or
at least one symbol of a downlink transmission corresponding to a physical unit conflicts with an uplink symbol configured by a network-side device.

17. The UE according to claim 15, wherein the program or instructions, when executed by the processor, cause the UE to further perform:
generating a hybrid automatic repeat request-acknowledgement (HARQ-ACK) codebook based on the first DCI, and generating HARQ bits corresponding to the first physical unit at a bit position corresponding to the first physical unit in the HARQ-ACK codebook.

18. The UE according to claim 17, wherein the program or instructions, when executed by the processor, cause the UE to perform any one of the following:
in a case that two codewords are configured for the first physical unit but space division multiplexing is not configured for the first physical unit, setting the HARQ bits corresponding to the first physical unit to a first preset quantity of ACKs or the first preset quantity of NACKs at the bit position corresponding to the first physical unit in the HARQ-ACK codebook; or
in a case that neither two codewords nor space division multiplexing is configured for the first physical unit, setting the HARQ bits corresponding to the first physical unit to a second preset quantity of NACKs or the second preset quantity of ACKs at the bit position corresponding to the first physical unit in the HARQ-ACK codebook.

19. The UE according to claim 17, wherein the bit position corresponding to the first physical unit in the HARQ-ACK codebook is determined based on any one of the following:
order information of physical units in a combination of the plurality of physical units that are scheduled jointly with the first DCI;
order information of indices of physical units in a combination of the plurality of physical units that are scheduled jointly with the first DCI;
first based on order information of physical units in a combination of the plurality of physical units that are scheduled jointly with the first DCI, and then based on order information of transport blocks in the plurality of physical units that are scheduled jointly with the first DCI;
first based on order information of transport blocks in the plurality of physical units that are scheduled jointly with the first DCI, and then based on order information of the plurality of physical units that are scheduled jointly with the first DCI;
first based on order information of indices of physical units in a combination of the plurality of physical units that are scheduled jointly with the first DCI, and then based on order information of transport blocks in the plurality of physical units that are scheduled jointly with the first DCI; or
first based on order information of transport blocks in the plurality of physical units that are scheduled jointly with the first DCI, and then based on order information of indices of physical units in the plurality of physical units that are scheduled jointly with the first DCI.

20. A network-side device, comprising a processor and a memory, wherein the memory stores a program or instructions that are executable on the processor, and when the program or instructions are executed by the processor, steps of the DCI processing method according to claim 11 are performed.
